(19) United States
(12) Patent Application Publication
(10) Pub. No.: US 2010/0011226 A1
(43) Pub. Date: Jan. 14, 2010

(54) DATA MANAGEMENT METHOD, DATA MANAGEMENT SYSTEM, AND DATA STORAGE SYSTEM

(76) Inventors: Yukihide Inagaki, Fujisawa (JP); Tsutomu Imai, Yokohama (JP)

Correspondence Address: MATTINGLY & MALUR, P.C., 1800 DIAGONAL ROAD, SUITE 370, ALEXANDRIA, VA, 22314, US

(21) Appl. No.: 12/394,153

(22) Filed: Feb. 27, 2009

(30) Foreign Application Priority Data
Jul. 14, 2008 (JP) 2008-182572

(51) Int. Cl. G06F 12/14

(52) U.S. Cl. 713/189

(57) ABSTRACT

Encrypted data and an encryption key used for the encrypted data are separately stored and managed. A first storage device stores an encrypted data block, predetermined information and first management information. The predetermined information includes key data for decrypting the encrypted data block and includes a requirement for using the encrypted data block. The first management information is used to manage the encrypted data block and includes a first storage address at which the predetermined information is stored. A host device transfers the predetermined information from the first storage device to a second storage device, causes second management information including a second storage address, at which the transferred predetermined information is stored and which is included in the second storage device to be stored in the second storage device.

### BACKGROUND OF THE INVENTION

The present invention relates to a data management technique for managing encrypted files.

Electronic data is occasionally stored and managed in an encrypted manner due to its confidentiality or the necessity to restrict its copying and reproduction in terms of copyright protection. One problem associated with data encryption is that when encrypted data is stored on a portable storage device and its encryption key is managed in a correlated manner with a particular host device, that storage device cannot be used with other host devices. Even when the encryption key is to be stored on that storage device, the encryption key fails to serve the purpose of data protection if information associated with the key can be copied easily onto other storage devices. In response to such problems, a large number of systems or storage devices have been proposed that store encryption keys and their associated information in a special limited-access area. Patent Document 1 (JP-A-2007-96817), for example, discloses a storage device and host device of that kind.

Possible methods for encrypting electronic data on a storage device include encrypting all the electronic data with a single encryption key and encrypting data by assigning an encryption key to each file or folder. In addition, there are cases where a file is divided into several areas, and the divided file areas are managed with different encryption keys or under different requirements for using the encryption keys. Non-Patent Document 1 (SAFIA (Security Architecture for Intelligent Attachment) Recording and Playback Device for iVDR-TV Recording Specification Version 1 2 0 http://www.safia-lb.com/doc/spec/SAFIA_RPD_TV_V120_{—}20080221.pdf, 2008) describes a method for dividing a digital broadcast content into areas smaller than an area for a certain reproduction time and encrypting the divided areas with different encryption keys. This method has a problem that the areas that require the different encryption keys need to be clearly recorded, and the encryption keys need to be correctly associated with the areas without an error. As a technique to avoid the above problem, a file system that incorporates the concept of “named stream” has been put to practical use. As an example of the file system, Non-Patent Document 2 (Optical Storage Technology Association (OSTA) Universal Disk Format Specification Revision 2.00 http://www.osta.org/specs/pdf/udf200.pdf, 1998) describes a file system standard that defines a named stream.

### SUMMARY OF THE INVENTION

Occasionally, encrypted data and its encryption keys need to be separately stored on different storage devices. In the case of data management by coupling encrypted data and its encryption keys within a single storage device, it is convenient to write related coupling information in a named data stream. However, when multiple encryption keys are used for encrypting data in a single file, its data management may become complex, unless management data closely related to the encrypted data is used, due to the necessity to record the coupling information between the encrypted data and the keys. In addition, when encryption keys are stored on different storage devices, it is difficult to correctly locate, with the use of a named stream of one of the storage devices, the key storage locations of the other storage devices. Thus, the challenge the invention is to meet is to separately manage encrypted data and its encryption keys with different storage devices such that the data and the keys are correctly retrieved without mismatches at a later time.

According to an aspect of the present invention, a data management method is performed by a first storage device and a host device connected with the first storage device and with a second storage device different from the first storage device. The first storage device stores an encrypted data block, predetermined information including key data for decrypting the encrypted data block and including a requirement for using the encrypted data block, and first management information that is used to manage the encrypted data block and includes a first address at which the predetermined information is stored. The data management method comprises the steps of: transferring the predetermined information from the first storage device to the second storage device by means of the host device; storing, in the second storage device, second management information including a second address at which the transferred predetermined information is stored, the second address being included in the second storage device; and deleting the first address that indicates an area storing the predetermined information and is included in the first management information stored in the first storage device.

According to another aspect of the present invention, in the data management method, the encrypted data block is obtained by dividing data required to be protected into a plurality of data pieces and encrypting the divided data pieces with the key data, and the host device causes an identifier for identifying an association between the first management information and the second management information to be included in the second management information, causes the second management information including the identifier to be stored in the second storage device, and overwrites the identifier in the first address in order to delete the predetermined information stored in the first address.

According to still another aspect of the present invention, a data management method is performed by a first storage device and a host device connected with the first storage device and with a second storage device different from the first storage device. The first storage device stores an encrypted data block and first management information used to manage the encrypted data block. The second storage device stores predetermined information and second management information. The predetermined information includes key data for decrypting the encrypted data block and includes a requirement for using the encrypted data block. The second management information associates the encrypted data block with a first address at which the predetermined information is stored. The data management method comprises the step of performing either one of a first process of transferring the predetermined information from the second storage device to the first storage device by means of the host device and causing the transferred predetermined information to be included in the first management information stored in a second address of the first storage device and a second process of transferring the encrypted data block and the first management information from the first storage device to the second storage device by means of the host device and causing the first address to be included in the transferred first management information to delete either one of a set of the encrypted data block and the first management information that are included in the first storage device, and a set of the predetermined information and the second management information that are included in the second storage device.

According to still another of the present invention, a data management system comprises: a first storage device storing an encrypted data block, predetermined information including key data for decrypting the encrypted data block and a requirement for using the encrypted data block, and first management information that is used to manage the encrypted data block and includes a first storage address at which the predetermined information is stored; a second storage device different from the first storage device; and a host device connected with the first and second storage devices and having a transfer section, a storage section and a deletion section, the transfer section being adapted to transfer the predetermined information from the first storage device to the second storage device, the storage section being adapted to cause second management information including a second storage address at which the transferred predetermined information is stored and which is included in the second storage device to be stored in the second storage device, the deletion section being adapted to delete the first storage address that indicates an area storing the predetermined information and is included in the first management information stored in the first storage device.

According to still another aspect of the present invention, a data storage system comprises: a first storage device having an area for storing an encrypted data block and an area for storing first management information used to manage the encrypted data block; and a second storage device that is different from the first storage device and has an area for storing predetermined information including key data for decrypting the encrypted data block and a requirement for using the encrypted data block and an area for storing second management information that includes information on a storage address of the area for storing the predetermined information and is associated with the first management information.

According to the present invention, encrypted data and an encrypted key used for the encrypted data can be separately managed.

These and other features, objects and advantages of the present invention will become more apparent from the following description when taken in conjunction with the accompanying drawings wherein:

### BRIEF DESCRIPTION OF THE DRAWINGS

FIG. 1 is a diagram showing the configuration of an information processing system according to a first embodiment;

FIG. 2 is a diagram showing a mutual relationship between information stored multiple storage devices;

FIG. 3 is a diagram showing layouts of information stored in multiple storage devices;

FIG. 4 is a flowchart showing a process for storing encrypted information stored in a storage device and storing a requirement for using the encrypted information in another storage device;

FIG. 5 is a flowchart showing a process for transferring the requirement for using the encrypted information to the storage device storing the encrypted information and managing the encrypted information and the requirement for using the encrypted information in an integrated manner;

FIG. 6 is a flowchart showing a process for transferring the encrypted information to the storage device storing the requirement for using the encrypted information and managing the encrypted information and the requirement for using the encrypted information in an integrated manner;

FIG. 7 is a diagram showing a layout of information stored in a single storage device;

FIG. 8 is a diagram showing a mutual relationship between information stored in the single storage device.

### DESCRIPTION OF THE EMBODIMENTS

Described hereinafter are preferred embodiments of the invention in which encrypted data to be protected and its encryption key information are separately managed with different storage devices.

### First Embodiment

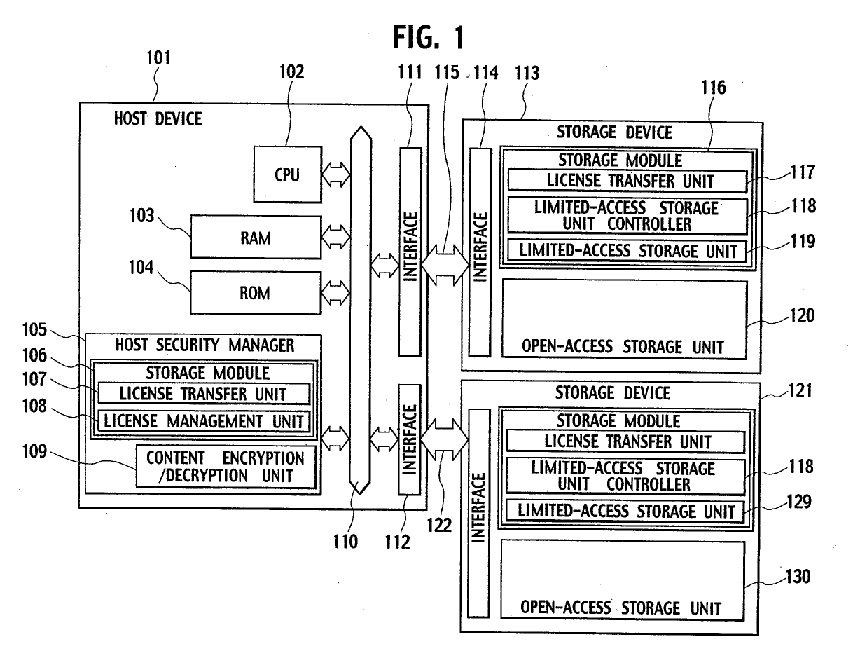

FIG. 1 is a configuration diagram of the information processing system of a first embodiment. A host device 101 in the information processing system is such an information processing device as computers and digital televisions. Reference numerals 113 and 121 denote portable storage devices of the same kind. The host device 101 is connected to the storage devices 113 and 121 via interfaces 115 and 122, respectively. The host device 101 includes a central processing unit (CPU) 102, or a main controller, and a main memory 103 that temporarily stores required data for the CPU's operations and some programs. The host device 101 also includes a non-volatile memory 104 that stores programs and data which do not require overwriting such as the boot program for the CPU 102. The host device 101 further includes a host security manager 105. The host security manager 105 includes a storage module 106 of a tamper-resistant structure and a content encryption/decryption unit 109. The storage module 106 includes a license transfer unit 107 and a license management unit 108. The host device 101 also has inter-device interfaces 111 and 112, which control the interfaces 115 and 122, respectively. The interface 115 is provided between the host device 101 and the storage device 113, the interface 122 being provided between the host device 101 and the storage device 121. The CPU 102, the main memory 103, the non-volatile memory 104, the host security manager 105, and the interfaces 111 and 112 are mutually connected through a bus 110.

The storage device 113 includes an interface 114 that controls the interface 115 connected to the host device 101; a storage module 116 of a tamper-resistant structure; and an open-access storage unit 120. The storage module 116 has a. The storage module 116 has a license transfer unit 117, a limited-access storage unit controller 118 and a limited-access storage unit 119. The open-access storage unit 120 does not restrict data writing thereon and data reading therefrom. By the user specifying a particular position inside the open-access storage unit 120 from the host device 101 via the interface 115, data can be freely written on or read from that position. In contrast, the limited-access storage unit 119 stores particular management information called a license. The license is encrypted by the license transfer unit 117 of the storage device 113 and by the license transfer unit of another device (e.g., the license transfer unit 107 of the host device 101) in accordance with predetermined authentication and transfer procedures. The limited-access storage unit 119 stores this encrypted license. Thus, the limited-access storage unit 119 does restrict data writing thereon and data reading therefrom, contrary to the open-access storage unit 120. The limited-access storage unit controller 118 is a control device for controlling license writing on and license reading from the limited-access storage unit 119 and controlling the operation of the license transfer unit 117.

The storage device 121 is the same as the storage device 113 in terms of configuration and operation and will not be discussed further.

The storage module 106 provided in the host device 101, a counterpart of the storage module 116, includes the license management unit 108 as stated above. The license management unit 108 manages licenses as data; for example, it restricts license transfer performed by the license transfer unit 107 and overwrites transfer records. Because the host security manager 105 is not intended as a storage unit, it does not require a memory area such as the limited-access storage unit 119.

When the host device 101 needs to store data in an encrypted manner on the storage device 113, the data is first encrypted by the content encryption/decryption unit 109, and the encrypted data is then stored on the open-access storage unit 120. Encryption keys used for the encryption and information such as on an initial vector are embedded in license information newly created by the license management unit 108. The license information also includes license IDs for identifying respective licenses and use conditions such as prohibition or restriction of license duplication. Licenses are stored by being transferred from the license transfer unit 107 of the host device 101 to the license transfer unit 117 of the storage device 113 through a safe communication method that prevents the licenses from being eavesdropped, falsified, and tampered.

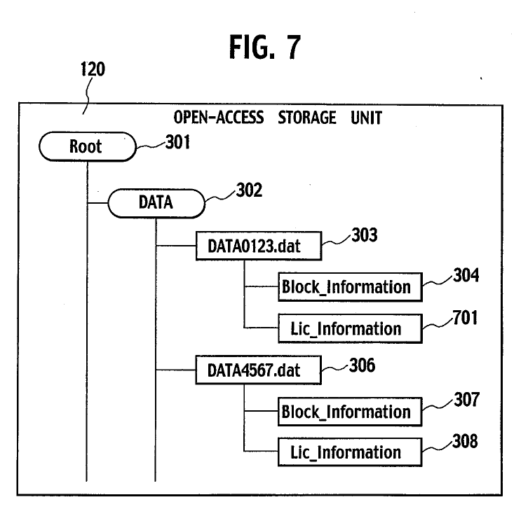

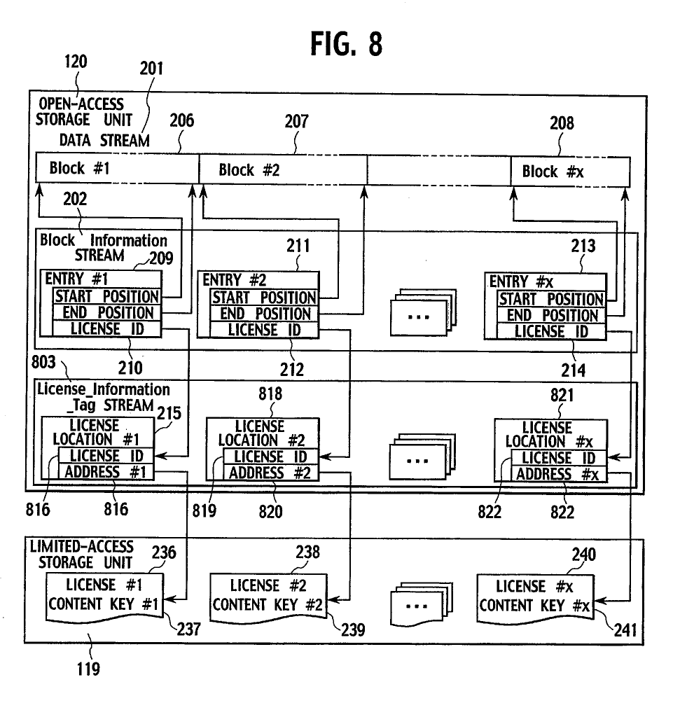

There are cases where data to be protected is divided into multiple sections, and those sections are managed by different encryption keys and under different use conditions. For an easier understanding of later explanations, described next with reference to FIGS. 7 and 8 is a data management method in which data to be protected and its associated encryption key information are stored on a single storage device.

In FIG. 8, the data to be protected is called a data stream 201. The data stream 201 is divided into multiple data blocks: Block #1 (206), Block #2 (207), . . . , and Block #x (208). These data blocks #1 to #x are encrypted by their respective encryption keys, that is, content key #1 (237), content key #2 (239), . . . , and content key #x (241), respectively. These encryption keys #1 to #x are written in License #1 (236), License #2 (238) . . . , and License #x (240), respectively, along with their use conditions. The licenses are stored on the limited-access storage unit 119 provided in the storage device 113.

A block information stream 202 (hereinafter referred to as Block_Info 202) and a license information stream 803 (hereinafter referred to as Lic_Info 803) are provided as management information so as to manage in a correlated manner each of the data blocks in the data stream 201 and their respective licenses. The Block_Info 202 retains information on the divided data blocks in the data stream 201 and on their respective licenses. The Block_Info 202 is a collection of fixed pattern data that is divided on an entry-by-entry basis. The Entry #1 (209) section of the Block_Info 202 retains information on the start and end positions of Block #1 (206) of the data stream 201 and on License ID (210) that identifies a corresponding license, that is, License #1. The Start and end positions of the other blocks of the data stream 201 and the licenses for the other blocks can be identified by referencing the entries #2 (211) to #x (213) of the Block_Info 202 in the same manner as the entry #1 (209). The Block_Info 202 specifies the licenses by means of the license IDs that are identifiers and indicate license information. Thus, the Block_Info 202 does not have information that indicates a storage area storing each of the licenses and included in the limited-access storage unit 119. The license IDs and storage addresses (storage areas) that are included in the limited-access storage unit 119 and store the respective licenses are described in the stream Lic_Info 803. The stream Lic_Info 803 is divided into predetermined license information. The license information includes license location information #1 (815), license location information #2 (818), . . . , and license location information #x (821). The license location information #1 (815), #2 (818), . . . , and #x (821) have license ID fields (816), (819) and (822) and address fields (817), (820), . . . , and (823), respectively. The license IDs are described in the respective license ID fields (816), (819), . . . , and (822). Addresses at which the licenses are stored in the limited-access storage unit 119 are described in the address fields (817), (820), . . . , and (823), respectively. Therefore, the license for Block #2 of the data stream 201 can obtain the license ID 212 from the entry #2 (211) of the Block_Info 202. In addition, the license for Block #2 of the data stream 201 can obtain the address #2 (820) indicative of the storage area of the limited-access storage unit 119 from the license location information #2 (818).

FIG. 7 is a diagram showing a layout of information stored in the storage device 113. The opening storage unit 120 has a root directory Root 301. The root directory Root 301 has a subdirectory DATA 302 for storing the information to be protected. Data streams are stored as main streams represented by file names such as DATA0123.dat (303) and DATA4567.dat (306). A named stream is created for each file name. A block information (Block_Information) stream or a license information (Lic_Information) stream is stored as the named stream. When the data stream 201 shown in FIG. 8 is stored with the file name DATA0123.dat (303), a named stream of Block_Information 304, which is attached to the file, is the Block_Info 202 included in the data stream 201. A named stream of Lic_Information 701 is the stream Lic_Info 803 included in the data stream 201.

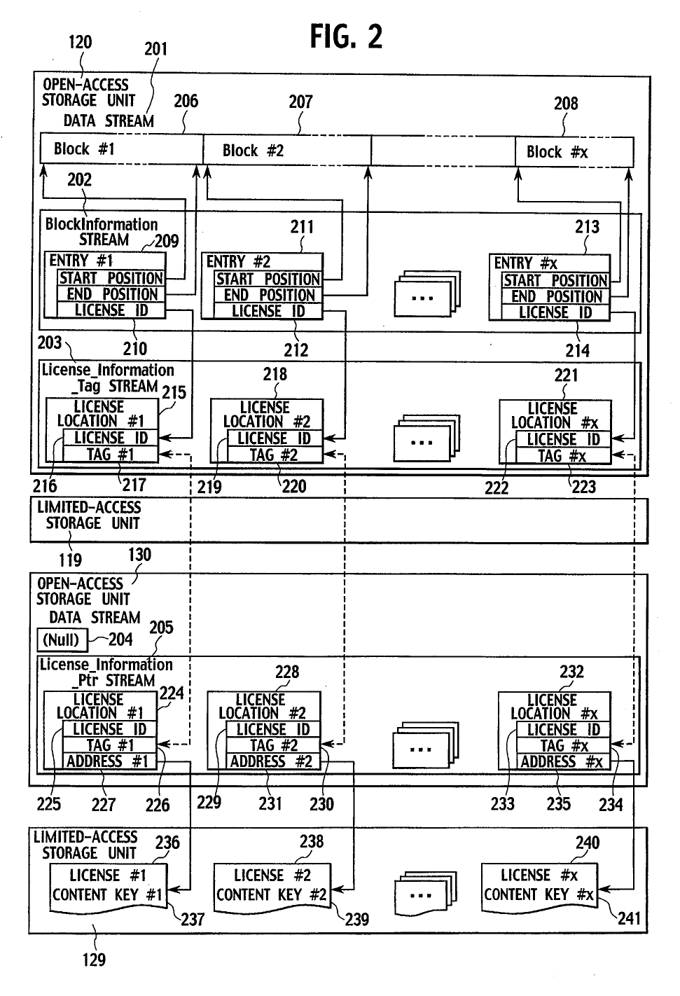

Next, a description is made of a static management method performed under the condition that data to be protected and information on an encryption key for the data are separated and stored in different storage devices, with reference to FIG. 2. FIG. 2 shows relationships among information stored in the multiple storage devices. FIG. 2 shows data stored in the open-access storage unit 120 and the limited-access storage unit 119 that are provided in the storage device 113, and data stored in the open-access storage unit 130 and the limited-access storage unit 129 that are provided in the storage device 121. A data stream 201 (shown in FIG. 2) that is data to be protected is stored in the storage device 113, while information on an encryption key for the data stream 201 (shown in FIG. 2) is stored in the storage device 121. The data stream 201 and a stream Block_Info 202 that are stored in the open-access storage unit 120 shown in FIG. 2 are the same as the data stream 201 and the Block_Info 202 that are stored in the open-access storage unit 120 shown in FIG. 8. Instead of the stream Lic_Info 803, a license information tag stream (hereinafter referred to as Lic_Info_Tag) 203 is described (and stored in the open-access storage unit 120 shown in FIG. 2). The Lic_Info_Tag 203 is created in the same format as that of the Lic_Info 803. The Lic_Info 803 has the address fields (817, 820 and 823) describing addresses as described above. The Lic_Info_Tag 203 has tag numbers (identifiers) in spaces (217, 220 and 223) corresponding to the address fields (817, 820 and 823). The limited-access storage unit 119 does not store a license related to the data stream 201. Licenses 236, 238 and 240 for the data stream 201 are stored in the limited-access storage unit 129 of the storage device 121. A stream License_Information_Ptr (hereinafter referred to as Lic_Info_Ptr) 205 is stored as management information in the open-access storage unit 130 instead of the Lic_Info 803. The stream Lic_Info_Ptr 205 may not be formed in the same format as that of the Lic_Info 803. The Lic_Info_Ptr 205 is also divided into license location information #1 (224), license location information #2 (228), . . . , and license location information #3 (232), which are provided for Blocks 206, 207, . . . , and Block 208, respectively. Each of the license location information has a field for storing a license ID, a field for storing a tag number, and a field for storing an address that indicates a storage area in which a license is stored. The field for storing a tag number stores a tag number described in the Lic_Info_Tag 203 stored in the open-access storage unit 120. That is, the fields 217 and 226 describe the same tag TAG #1; the fields 220 and 230 describe the same tag TAG #2; and the fields 223 and 234 describe the same tag TAG #x, as represented by broken arrows shown in FIG. 2. The address fields describe addresses, at which licenses for the blocks are stored and which are located in the limited-access storage unit 129, like the Lic_Info 803. A data stream 204 stored in the open-access storage unit 130 is a null stream. A file is defined in the null stream. The null stream does not include entity information.

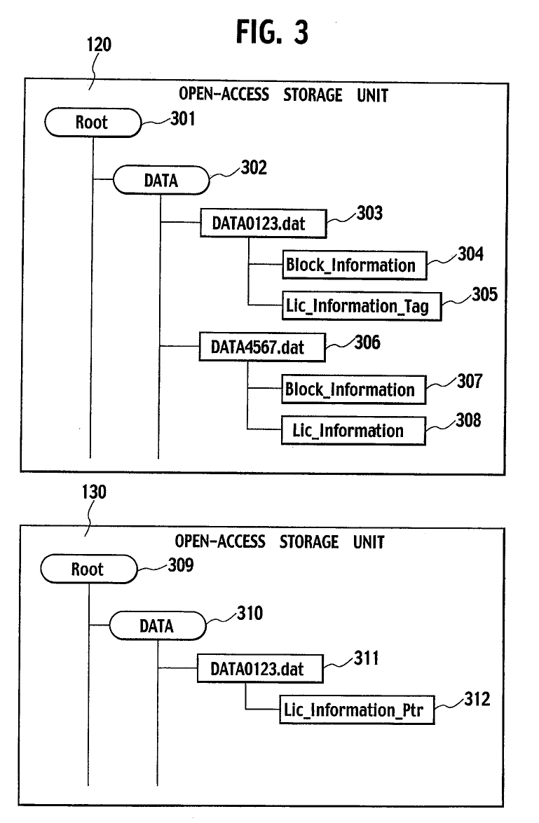

FIG. 3 is a diagram showing a layout of information stored in the storage device 121 and a layout of information stored in the storage device 130. The opening storage unit 120 has a root directory Root 301. The root directory Root 301 has a subdirectory DATA 302 for storing the information to be protected. Data streams are stored as main streams represented by file names such as DATA0123.dat (303) and DATA4567.dat (306). A named stream is created for each file name. A block information stream or a license information stream is stored as the stream with the name. When the license for the stream with the name is stored in the storage device 113, the stream with the name has a license information tag (Lic_Info_Tag) 305 instead of the Lic_Info 803.

When the data stream 201 shown in FIG. 2 is stored with a file name of DATA0123.dat (303), a stream (attached to the file) with a name of Block_Information 304 is the Block_Info 202 included in the data stream 201, and a named stream of Lic_Information_Tag 305 is the Lic_Info_Tag 215 included in the data stream 201. The data stream 204 (null stream) stored in the open-access storage unit 130 is stored with a name associated with the data stream 303 having original entity data, like DATA0123.dum311 shown in FIG. 3. A named stream of Lic_Information_Ptr 312 attached to the file corresponds to Lic_Info_Ptr 205 shown in FIG. 2.

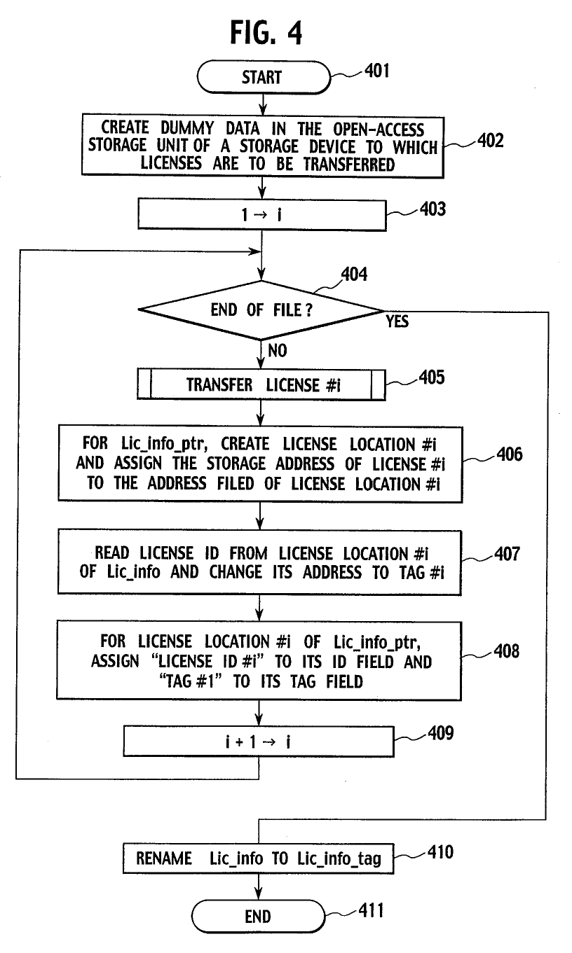

FIG. 4 is a flowchart showing a process performed in the case where data required to be protected and information on an encryption key for the data required to be protected are stored in a single storage device, and a license is then transferred from the storage device to another storage device under the condition that the data required to be protected remains in the storage device. The process is performed to change the state shown in FIG. 8 to the state shown in FIGS. 2 and 3. When the process starts in step 401, an empty data file (data stream) 204 is created and stored in the open-access storage unit 130 of the storage device 121 to which the license is to be transferred in step 402. In this case, the empty data file 204 is created to ensure that a named stream of Lic_Info_Ptr 205 can be added when necessary. Next, a value of 1 is assigned to a variable i in step 403, and a license corresponding to the variable i is transferred from the storage device 113 to the storage device 121 in step 405. The transfer of a license between storage devices, and copying, reading and writing of a license are performed by the license transfer units 107, 117 and the like. Every time a single license is transferred to the limited-access storage unit 129, new license location information is added to the Lic_Info_Ptr 205. An address of the limited-access storage unit 129, at which the transferred license is stored, is stored in an address field of the added license location information in step 406. Then, a license ID specifying the license is read from the license location information #i, and a unique TAG #i is created based on the variable i and written in the address field in step 407. An address (e.g., address #1 (817)) originally stored in the address field is unnecessary since the license is transferred. Thus, the TAG #i may be written over the originally stored address. The same TAG #i is written in a tag field of the license location information #i of the Lic_Info_Ptr 205, and the read license ID is written in a license ID field of the license location information #i of the Lic_Info_Ptr 205 in step 408. Then, a value of 1 is added to the variable i to transfer a license corresponding to the variable i+1. Steps 404 to 409 are repeated until all licenses are transferred. After the process for transferring License #x 240 is completed, the name of the Lic_Info 803 stored in the open-access storage unit 120 is changed to Info_Tag 203 in step 410. Then, the process shown in FIG. 4 is completed in step 411.

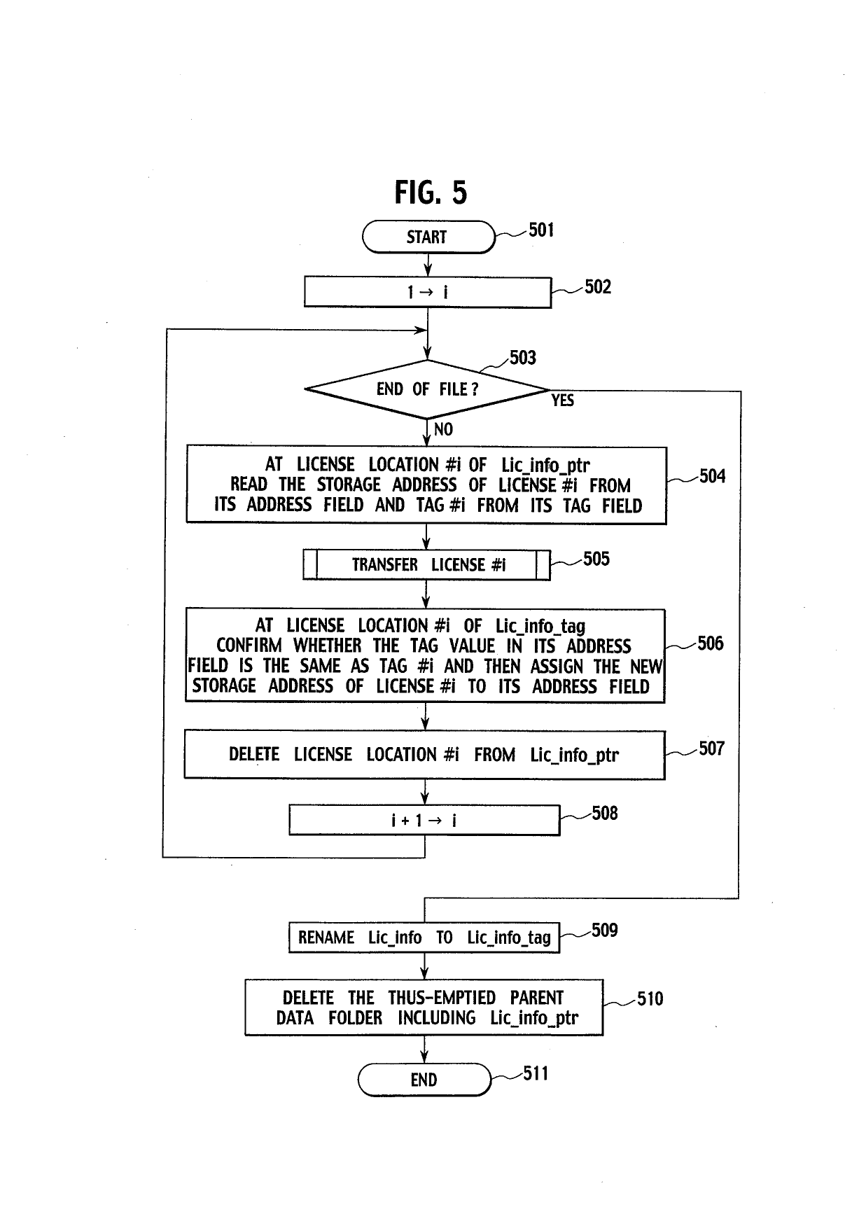

FIG. 5 is a flowchart showing a process performed in the case where data required to be protected and information on an encryption key for the data required to be protected are stored in different storage devices, and a license is then transferred to the storage device in which the data required to be protected is stored. The process shown in FIG. 5 is to change the state shown in FIGS. 2 and 3 to the state shown in FIGS. 7 and 8. The process shown in FIG. 5 starts in step 501. Then, a value of 1 is assigned to a variable i in step 502. The TAG #i and an address at which the license is stored are read from license location information #i of the Lic_Info_Ptr 205 in step 504. The license corresponding to the variable i is transferred from the storage device 121 to the storage device 113 based on the read license storage address in step 505. Then, the value of a tag stored in an address field of the license location information #i of the Lic_Info_Tag 203 is read to confirm whether or not the read tag is the same as the TAG #i read in step 504. Then, an address of the limited-access storage unit 119, at which the transferred license is stored, is overwritten in the address field of the license location information #i of the Lic_Info_Tag 203 in step 506. After steps 501 to 506 are successfully performed, the license location information #i of the Lic_Info_Ptr 205 is deleted in step 507. Then, a value of 1 is added to the variable i to ensure that a license corresponding to the variable i+1 is transferred. Steps 503 to 508 are repeated until all licenses are transferred. After the process for transferring License #x 240 is completed, the name of the Lic_Info_Tag 203 stored in the open-access storage unit 120 is changed to Info_Info 803 in step 509. Then, the null data stream 204 including the Lic_Info_Ptr 205 stored in the open-access storage unit 130 is deleted in step 510. Then, the process shown in FIG. 5 is completed in step 511.

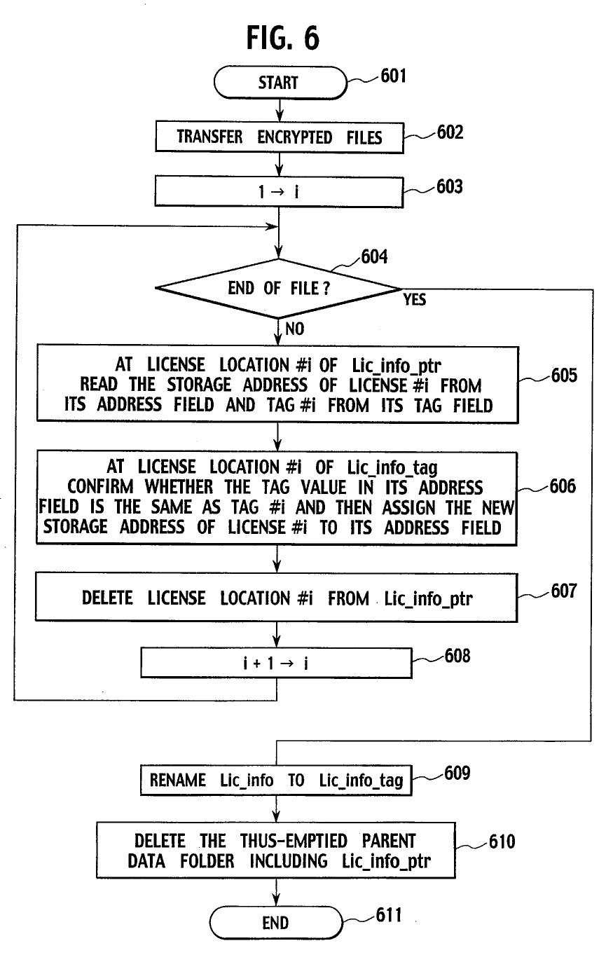

FIG. 6 is a flowchart showing another process performed in the case where data required to be protected and information on an encryption key for the data required to be protected remain in different storage devices, and the data required to be protected is then transferred to the storage device in which a license is stored. The process is performed to change the state shown in FIG. 2 and 3 to the state shown in FIGS. 7 and 8. The process starts in step 601. The encrypted data stream 201 is transferred from the open-access storage unit 120 to the open-access storage unit 130 in step 602. In this case, the stream with the name of Block_Info 202 and the stream with the name of Lic_Info_Tag 203, which are included in the data stream 201, are transferred to the open-access storage unit 130. In this case, since an empty data stream 204 and a Lic_Info_Ptr 205, which correspond to the data stream 201 transferred to the open-access storage unit 130, are found, processing starts to integrate the data stream 201 with the empty data stream 204 and the Lic_Info_Ptr 205. An initial value of 1 is assigned to the variable i in step 603. Then, an address at which a license is stored and a TAG #i are read from the license location information #i of the Lic_Info_Ptr 205 in step 605. Then, step 606 is performed to read the value of the tag stored in the address field of the license location information #i of the Lic_Info_Tag 203, confirm whether or not the read tag is the same as the TAG #i read in step 605, and overwrite the address read in step 605 in the address field of the license location information #i of the Lic_Info_Tag 203. After steps 601 to 606 are successfully performed, the license location information #i of the Lic_Info_Ptr 205 is deleted in step 607. Then, a value of 1 added to the variable i to ensure that a license for the variable i+1 is transferred. Steps 604 to 608 are repeated until all licenses are transferred. After the process for transferring License #x 240 is completed, the name of the Lic_Info_Tag 203 stored in the open-access storage unit 130 is changed to Info_Info 803 in step 609. Then, the null data stream 204 including the Lic_Info_Ptr 205 stored in the open-access storage unit 130 is deleted in step 610. Then, the process shown in FIG. 6 is completed in step 611.

According to the present embodiment, it is possible to store encrypted data and encryption keys in different storage devices and manage the encrypted data and the encryption keys.

According to the present embodiment, since tag data capable of being mutually referenced is added to management information included in encrypted data and to management information used to manage a storage area for storing an encryption key, the storage areas can be included in a single storage device or can be included in different storage devices without disturbing a relationship between the encrypted data and the encryption key.

### Second Embodiment

The second embodiment is described below. In the first embodiment, the Lic_Info_Tag 215 and the Lic_Info_Ptr 205 are stored in the storage device 113 and in the storage device 121, respectively, and the same TAG #i is stored in the storage devices 113 and 121 as an identifier to reference the license location information included in the Lic_Info_Tag 215 and in the Lic_Info_Ptr 205. However, when the process for separating a storage area at which a data stream is stored from a storage area at which a license is stored, or the process for integrating a storage area at which a data stream is stored with a storage area at which a license is stored, is performed on the first to last blocks of the data stream in this order as a rule, it is not necessary that the TAG #i be stored. In the second embodiment, the address field of the Lic_Info_Tag 203 does not include tag data and is empty, and the Lic_Info_Ptr 205 does not include a tag field.

According to the second embodiment, a process related to tag data is not necessary. It is therefore possible to easily perform the process for separating a storage area at which a data stream is stored from a storage area at which a license is stored, and the process for integrating a storage area at which a data stream is stored with a storage area at which a license is stored.

### Third Embodiment

The third embodiment is described below. In the third embodiment, either one or both of the storage devices 113 and 121 is or are remotely connected to the host device through a network. It is general that the interfaces 115 and 122 shown in FIG. 1 are standard interfaces for storage devices, such as interfaces complying with Advanced Technology Attachment (ATA), small computer system interfaces (SCSI), interfaces complying with Serial Advanced Technology Attachment (SATA), interfaces complying with a Fibre Channel standard, or serial attached SCSIs. For example, network interfaces are connected with both ends of the interface 122, respectively, and a network is established under the condition that commands of the interfaces for the storage devices and a protocol(s) for the interfaces for the storage devices are encapsulated. The storage device 121 is provided in a delivery server (that is remote from the host device) on the Internet to ensure that data to be protected and an encryption key for the data to be protected are separately delivered in the third embodiment.

In accordance with the embodiments, since storage devices and a host device only need be remotely connected through a network, the storage devices need not necessarily be portable, thus increasing the latitude in selecting storage devices to be used.

In accordance with the above-described embodiments of the invention, encrypted data and its encryption keys are separately managed with different storage devices. Thus, even when data is encrypted in a divided manner with multiple encryption keys or under multiple encryption conditions, the encrypted data and the encryption keys can be separately handled without affecting the mutual relation between the encryption positions and their corresponding encryption/decryption keys. This provides the following advantages over the case where encrypted data and its encryption keys are managed with a single storage device.

First, by encrypting confidential data with encryption keys and managing the data and the keys with different storage devices, the data and its encryption/decryption keys can be distributed easily via different routes at different times. Documents files to be opened by a particular recipient are often distributed in this manner.

Secondly, when electronic content, such as images and music, whose intellectual properties need to be protected is distributed for sale, what is called a superdistribution service model can be realized in which only its encrypted data is distributed in advance over the Internet or with portable media and its encryption keys necessary for playing the data are thereafter sold at a certain price.

Moreover, the invention advantageously increases the user's latitude in protecting data. For example, the user can back up only encrypted files or only encryption keys onto several storage devices.

Furthermore, since encrypted data and its encryption/decryption keys can be separately distributed in order for the electronic information in the data to be protected from unauthorized copying or the like, the latitude in handling confidential or copyrighted data can be increased. Thus, the invention is applicable to information security management within a firm or to business-to-consumer data delivery services.

What is claimed is:

1. A data management method performed by a first storage device and a host device connected with a second storage device different from the first storage device, the first storage device storing an encrypted data block, predetermined information and first management information, the predetermined information including key data for decrypting the encrypted data block and including a requirement for using the encrypted data block, the first management information being used to manage the encrypted data block and including a first storage address at which the predetermined information is stored, the method comprising the steps of:
transferring the predetermined information from the first storage device to the second storage device by means of the host device;
storing, in the second storage device, second management information including a second storage address at which the transferred predetermined information is stored, the second storage address being included in the second storage device; and
deleting the first storage address that indicates an area storing the predetermined information and is included in the first management information stored in the first storage device.

2. The data management method according to claim 1, wherein
the encrypted data block is obtained by dividing data required to be protected into a plurality of data pieces and encrypting the divided data pieces with the key data, and
the host device causes an identifier for identifying an association between the first management information and the second management information to be included in the second management information, causes the second management information including the identifier to be stored in the second storage device, and overwrites the identifier in the first storage address in order to delete the predetermined information stored in the first storage address.

3. The data management method according to claim 2, wherein
at least one of the first and second storage devices is connected with the host device through a network.

4. A data management method performed by a first storage device and a host device connected with a second storage device different from the first storage device, the first storage device storing an encrypted data block and first management information used to manage the encrypted data block, the second storage device storing predetermined information and second management information, the predetermined information including key data for decrypting the encrypted data block and including a requirement for using the encrypted data block, the second management information associating the encrypted data block with a first storage address at which the predetermined information is stored, the method comprising the step of:
performing either one of a first process of transferring the predetermined information from the second storage device to the first storage device by means of the host device and causing the transferred predetermined information to be included in the first management information stored in a second storage address of the first storage device and a second process of transferring the encrypted data block and the first management information from the first storage device to the second storage device by means of the host device and causing the first storage address to be included in the transferred first management information to delete either one of a set of the encrypted data block and the first management information that are included in the first storage device, and a set of the predetermined information and the second management information that are included in the second storage device.

5. The data management method according to claim 4, wherein
the encrypted data block is obtained by dividing data required to be protected into a plurality of data pieces and encrypting the divided data pieces with the key data, and
the host device references an identifier for identifying an association between the first management information and the second management information to associate the encrypted data block with the predetermined information.

6. The data management method according to claim 5, wherein
at least one of the first and second storage devices is connected with the host device through a network.

7. A data management system comprising:
a first storage device storing an encrypted data block, predetermined information, and first management information, the predetermined information including key data for decrypting the encrypted data block and including a requirement for using the encrypted data block, the first management information being used to manage the encrypted data block and including a first storage address at which the predetermined information is stored;
a second storage device different from the first storage device; and
a host device connected with the first and second storage devices and having a transfer section, a storage section and a deletion section, the transfer section being adapted to transfer the predetermined information from the first storage device to the second storage device, the storage section being adapted to cause second management information including a second storage address at which the transferred predetermined information is stored and which is included in the second storage device to be stored in the second storage device, the deletion section being adapted to delete the first storage address that indicates an area storing the predetermined information and is included in the first management information stored in the first storage device.

8. The data management system according to claim 7, wherein
the encrypted data block is obtained by dividing data required to be protected into a plurality of data pieces and encrypting the divided data pieces with the key data,
the storage section causes an identifier for identifying an association between the first management information and the second management information to be included in the second management information, and causes the second management information including the identifier to be stored in the second storage device, and
the deletion section overwrites the identifier in the first storage address that indicates the area storing the predetermined information and is included in the first management information stored in the first storage device in order to delete the first storage address that indicates the area storing the predetermined information.

9. The data management system according to claim 7, wherein
at least one of the first and second storage devices is connected with the host device through a network.

10. A data storage system comprising:
a first storage device having an area for storing an encrypted data block and an area for storing first management information used to manage the encrypted data block; and
a second storage device that is different from the first storage device and has an area for storing predetermined information and an area for storing second management information, the predetermined information including key data for decrypting the encrypted data block and including a requirement for using the encrypted data block, the second management information including information on a storage address of the area for storing the predetermined information and being associated with the first management information.

11. The data storage system according to claim 10, wherein,
the encrypted data block is obtained by dividing data required to be protected into a plurality of data pieces and encrypting the divided data pieces with the key data.

12. The data storage system according to claim 11, wherein
the area for storing the first management information includes an area for storing a first identifier that identifies a start position of the data block, an end position of the data block and the predetermined information and an area for storing a second identifier that identifies an association between the first identifier and the second management information, and
the area for storing the second management information includes an area for storing the first and second identifiers.

13. The data storage system according to claim 12, wherein
a specified controller controls writing and reading of the predetermined information in and from the area for storing the predetermined information.
